(19) United States
(12) Patent Application Publication
(10) Pub. No.: US 2012/0284652 A1
(43) Pub. Date: Nov. 8, 2012

(54) HUMAN-ENVIRONMENT INTERACTIVE SYSTEM AND PORTABLE DEVICE USING THE SAME

(75) Inventors: Chung-Hsien Kuo, New Taipei City (TW); Jiann-Jone Chen, New Taipei City (TW); Han-Yen Yu, Yilan County (TW); Chen-Han Lee, New Taipei City (TW); Rui-Zhe Zhang, Taipei City (TW)

(73) Assignee: National Taiwan University of Science and Technology, Taipei (TW)

(21) Appl. No.: 13/165,815

(22) Filed: Jun. 22, 2011

(30) Foreign Application Priority Data
May 5, 2011 (TW) 100115753

(51) Int. Cl. G06F 3/048

(52) U.S. Cl. 715/760

(57) ABSTRACT

A human-environment interactive system and a portable device using the same are provided. The human-environment interactive system includes a ubiquitous computing system, at least one home-equipment, and the portable device. The portable device is suitable for two-way communicating with the portable device, and includes a RF transceiver, a browser, and a controller. When the portable device is taken into an environmental space, the controller actively receives a set of situational information from the ubiquitous computing system through the RF transceiver. The situational information includes a status information of at least one home-equipment, and a real time position information of the portable device. The controller displays this set of situational information in the browser for a user to perceive variations of the surrounding environment, so as to operate the at least one home-equipment through the browser.

### CROSS-REFERENCE TO RELATED APPLICATION

This application claims the priority benefit of Taiwan application serial no. 100115753, filed May 5, 2011. The entirety of the above-mentioned patent application is hereby incorporated by reference herein and made a part of this specification.

### BACKGROUND OF THE INVENTION

1. Field of the Invention

The invention relates to a humanist technology. Particularly, the invention relates to a human-environment interactive system and a portable device using the same.

2. Description of Related Art

Modern people have limited living spaces, and for a wheelchair user, small spaces lead to a lot of inconveniences, for example, it is not easy for the wheelchair user to open a door, a window or turn on/off the light. Even more, when a visitor knocks the door, the wheelchair user cannot quickly learn whether the visitor is a friend or a stranger. Similarly, those disabled people also have a mobility problem, and the elderly people have a problem of visual degradation, so that these people have a great inconvenience in life. Therefore, it is an important issue to develop technology based on human needs to take care of these people with limited mobility, and make human life more convenient and perfect.

### SUMMARY OF THE INVENTION

The invention is directed to a human-environment interactive system and a portable device using the same. An environmental space where a user is located is actively informed to the user through the portable device, and the user is capable of conveniently operating various home-equipment through a browser of the portable device.

The invention provides a human-environment interactive system including a ubiquitous computing system, at least one home-equipment, and a portable device. The ubiquitous computing system has a plurality of computing devices. The at least one home-equipment is located in an environmental space. The portable device and the ubiquitous computing system are suitable for two-way communication. The portable device includes a radio frequency (RF) transceiver, a browser, and a controller. The controller is coupled to the RF transceiver and the browser. When the portable device is taken into the environmental space, the controller actively receives a set of situational information related to the environmental space from the ubiquitous computing system through the RF transceiver. The set of situational information includes status information of the at least one home-equipment, and real-time position information of the portable device. The controller displays the set of situational information in the browser for a user to perceive variations of the surrounding environment, so as to operate the at least one home-equipment through the browser.

The invention provides a portable device, which is suitable for two-way communicating with a ubiquitous computing system. The ubiquitous computing system has a plurality of computing devices. The portable device includes a radio frequency (RF) transceiver, a browser, and a controller. The controller is coupled to the RF transceiver and the browser. When the portable device is taken into an environmental space, the controller actively receives a set of situational information related to the environmental space from the ubiquitous computing system through the RF transceiver. The set of situational information includes status information of at least one home-equipment, and real-time position information of the portable device. The controller displays the set of situational information in the browser for a user to perceive variations of the surrounding environment, so as to operate the at least one home-equipment through the browser.

In an embodiment of the invention, the human-environment interactive system further includes a first pan-tilt-zoom camera coupled to the controller, and the first pan-tilt-zoom camera displays a first camera image in the browser according to an operation of the user.

In an embodiment of the invention, the portable device is disposed on a smart carrier.

In an embodiment of the invention, the portable device further includes a pan-tilt-zoom camera coupled to the controller, and the pan-tilt-zoom camera captures a first camera image to display in the browser according to an operation of the user.

In an embodiment of the invention, the portable device is a mobile phone, a global positioning system (GPS) navigation apparatus, a personal digital assistant (PDA) or a computer device.

In an embodiment of the invention, a two-way communication protocol between the portable device and the ubiquitous computing system is an infrared protocol, a bluetooth protocol or a wireless fidelity (Wi-Fi) protocol.

In an embodiment of the invention, the user performs operations through a graphical user interface of the browser, where the graphical user interface is a static graphical interaction interface or a reality interactive interface.

In an embodiment of the invention, the reality interactive interface is a virtual reality graphical control interface or an augmented reality control interface.

In an embodiment of the invention, the at least one home-equipment includes a second pan-tilt-zoom camera, and the user performs remote control to the second pan-tilt-zoom camera through the browser, and displays a second camera image on the browser, so as to provide the image to the reality interactive interface of the browser.

In an embodiment of the invention, the at least one home-equipment is an electric lamp, an electric fan, an electric air conditioner, an electric heater, an audio-visual equipment, an electric door, an electric window or an electric curtain.

In an embodiment of the invention, the real-time position information is wireless RF identification (RFID) coordinates or wireless positioning coordinates.

In an embodiment of the invention, when the user operates the at least one home-equipment through the browser, the portable device sends a wireless control signal to control an operation of the at least one home-equipment.

According to the above description, the human-environment interactive system and the portable device using the same are integrated with a wireless and space positioning technique to provide an overall solution for people with limited mobility. In this way, these people can easily operate the home-equipment, which resolves inconvenience of daily life, and makes human life more convenient and perfect.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a human-environment interactive system according to an embodiment of the invention.

FIG. 2 is a schematic diagram of a control method of a plurality of rooms according to an embodiment of the invention.

FIG. 3 is a circuit block diagram of a portable device according to another embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

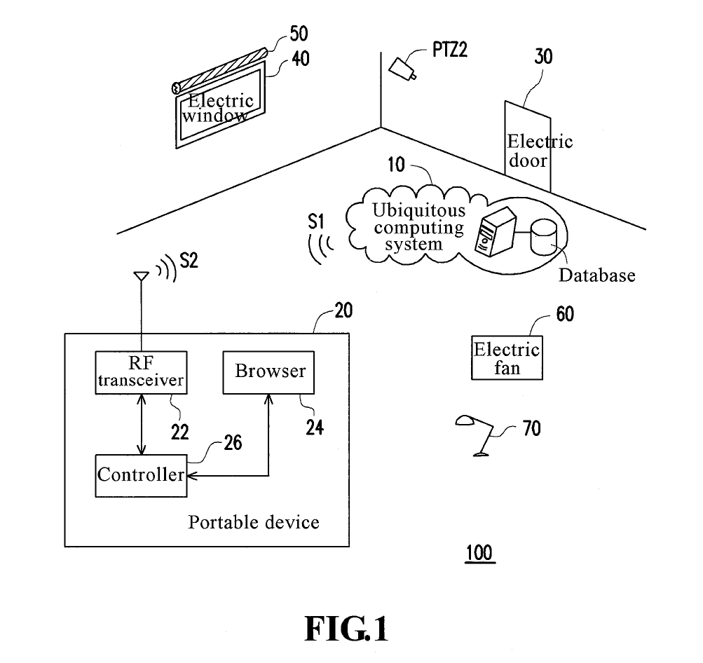

FIG. 1 is a diagram of a human-environment interactive system according to an embodiment of the invention. Referring to FIG. 1, the human-environment interactive system 100 includes a ubiquitous computing system 10, at least one home-equipment and a portable device 20. The portable device 20 and the ubiquitous computing system 10 are suitable for two-way communication.

First, the ubiquitous computing system 10 is defined. With progress of network services, various computing devices can be connected without limiting to a regular computer type, where a database can be connected and one of the computing devices or the database may store a plurality of sets of situational information of a plurality of environmental spaces. Based on such ubiquitous computing pattern, the computing power of the computers can fully penetrate into life, which is referred to as the ubiquitous computing system 10. Within a coverage range of the ubiquitous computing system 10, the portable device 20 can obtain and process information through a wireless manner at any time and any place. The information of the ubiquitous computing system 10 can be transmitted to the portable device 20 at all times and places.

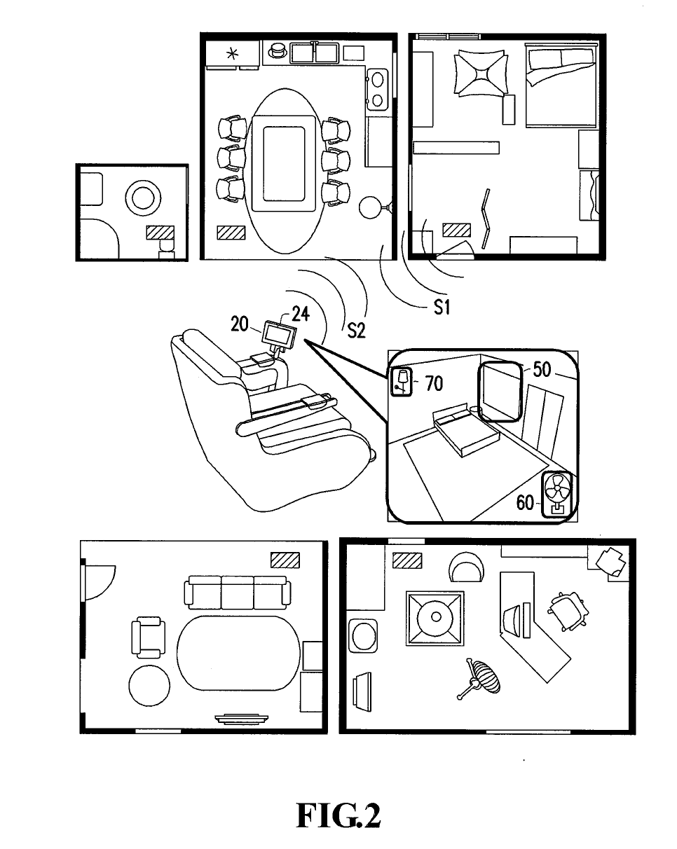

The portable device 20 may include a radio frequency (RF) transceiver 22, a browser 24 and a controller 26. The controller 26 is coupled to the RF transceiver 22 and the browser 24. The home-equipment includes an electric door 30, an electric window 40, a pan-tilt-zoom camera PTZ2, an electric curtain 50, an electric fan 60 or an electric lamp 70, etc., and may also include an electric air conditioner, an electric heater and an audio-visual equipment that are not illustrated, though the invention is not limited thereto. FIG. 2 is a schematic diagram of a control method of a plurality of rooms, and in FIG. 2, scene switch of a plurality of rooms is illustrated, in which the home-equipment can be located in an environmental space of a living room or a conference room, etc.

When the portable device 20 is taken into a current environmental space, the controller 26 actively receives a set of situational information S1 related to the environmental space from the ubiquitous computing system 10 through the RF transceiver 22, where the set of situational information S1 may include status information of the electric door 30, the electric window 40, the pan-tilt-zoom camera PTZ2, the electric curtain 50, the electric fan 60 or the electric lamp 70, and real-time position information of the portable device 20. Further, the situational information Si may also include a picture of the environmental space. The pan-tilt-zoom camera PTZ2 can adjust a pan angle and a tilt angle to achieve a better camera effect. The real-time position information can be obtained according to an existing positioning technique. For example, the real-time position information can be RF identification (RFID) coordinates or wireless positioning coordinates.

Then, the controller 26 displays the set of situational information S1 in the browser 24. The browser 25 can be a touch screen having a graphical user interface (GUI). The GUI can present various information of the environmental space and positions of the home-equipment to the user to facilitate real-time interaction of life demand. Icons and titles of various windows can be displayed in the GUI to ensure operability and visibility of the human-environment interactive system, so as to facilitate the user to perform management through the windows. The GUI can be a static graphical interaction interface or a reality interactive interface.

It should be noticed that the reality interactive interface can be a virtual reality graphical control interface or an augmented reality control interface. The augmented reality control interface can be a reality interactive system, which uses the pan-tilt-zoom camera to display the positioning coordinates via reality visual information.

FIG. 2 is a schematic diagram of a control method of a plurality of rooms according to an embodiment of the invention. Referring to FIG. 2, in another embodiment, when the portable device 20 is taken into a first room, the browser 24 actively displays various information related to the first room. When the portable device 20 is moved to a second room, the browser 24 actively displays various information related to the second room. Moreover, the portable device 20 can transmit an identification signal representing the user, so that the ubiquitous computing system 10 can authorize the portable device 20 to use the home-equipment in the room.

Therefore, the portable device 20 facilitates the user to perceive variations of the surrounding environment and learn a current space where the portable device 20 is located, or learn relative positions between the portable device 20 and various home-equipment, and/or learn the home-equipment that are authorized for utilization. In this way, the portable device 20 is unnecessary to store the situational information S1 of the environmental space in advance, and the user is unnecessary to walk and search switches of the related equipment. The GUI is a well-known technique for those skilled in the art, so that a detailed description thereof is not repeated.

When the user is a wheelchair user, a disabled person or an elderly person, the portable device 20 facilitates the user to operate various home-equipment such as the electric door 30, the electric window 40, the pan-tilt-zoom camera PTZ2, the electric curtain 50, the electric fan 60 or the electric lamp 70, etc. though the browser 24. For example, the user can respectively open the electric door 30 and the electric window 40. For example, the user can use the pan-tilt-zoom camera PTZ2 as an assistant visual tool, and operates the pan-tilt-zoom camera PTZ2 through the reality interactive interface of the browser 24, and meanwhile the user can view images provided by the pan-tilt-zoom camera PTZ2 through the reality interactive interface of the browser 24, so as to observe details of the room.

Another example is provided below for description. It is assumed that the pan-tilt-zoom camera PTZ2 is located outside the house and is aligned to the door, the user can operate the pan-tilt-zoom camera PTZ2 from the GUI of the browser 24. The portable device 20 can send a wireless control signal S2 to control the pan-tilt-zoom camera PTZ2. The control method is to directly control the pan-tilt-zoom camera PTZ2, or indirectly control the pan-tilt-zoom camera PTZ2 through the ubiquitous computing system 10. The pan-tilt-zoom camera PTZ2 can directly send signals of the camera images to the portable device 20 through a wireless manner, or the pan-tilt-zoom camera PTZ2 first sends signals of the camera images to the ubiquitous computing system 10 through a cable manner, and then the ubiquitous computing system 10 sends the signals of the camera images to the portable device 20 through a wireless manner. Then, the browser 24 displays the camera images. In this way, the user can view a door scene in real-time, so as to learn whether a friend drops by at the doorway. However, the above embodiment is only used to describe the concept of the invention, and is not used to limit actual applications of the invention.

It should be noticed that a two-way communication protocol between the portable device 20 and the ubiquitous computing system 10 can be an infrared protocol, a bluetooth protocol or a wireless fidelity (Wi-Fi) protocol. Similarly, a two-way communication protocol between the portable device 20 and the pan-tilt-zoom camera PTZ2 can also be the infrared protocol, the bluetooth protocol or the wireless fidelity (Wi-Fi) protocol. However, the invention is not limited thereto, and other types of wireless transmission protocol can also be used.

Moreover, the portable device 20 can be a mobile phone, a global positioning system (GPS) navigation apparatus, a personal digital assistant (PDA) or a computer device.

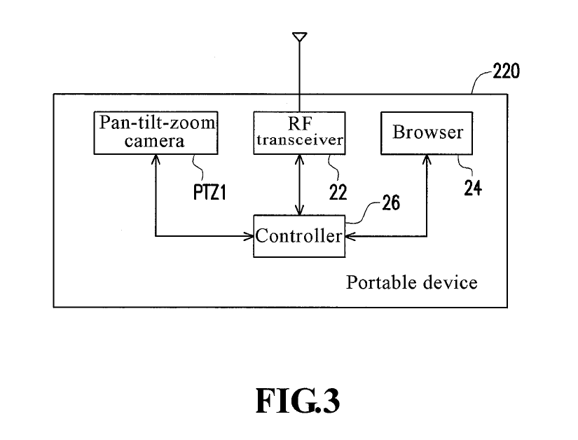

FIG. 3 is a circuit block diagram of a portable device according to another embodiment of the invention. Referring to FIG. 3, the portable device 220 is a variation of the portable device 20. The portable device 220 can be installed on a smart carrier, for example, the portable device 220 can be installed on an electric wheelchair, and the portable device 220 may include a RF transceiver 22, a browser 24, a controller 26 and a pan-tilt-zoom camera PTZ1. The pan-tilt-zoom camera PTZ1 can adjust a pan angle and a tilt angle to achieve a better camera effect. The user can operate the pan-tilt-zoom camera PTZ1 through the browser 24, or the electric wheelchair may have operation buttons (or a joystick) of the pan-tilt-zoom camera PTZ1, and the camera images are displayed on the browser 24. In this way, besides a real-time interaction with the situation of the environmental space is performed, a visual perception of an asthenope or a person with limited mobility is also enhanced, which facilitates the user to view a scenery, or search for a book on a bookcase, or real-time interact with friends.

Although several possible patterns of the human-environment interactive system and the portable device using the same have been described in the above embodiments, it should be understood by those skilled in the art that application of the present invention should not be limited to the above possible patterns. In other words, the spirit of the present invention is met as long as the portable device actively notify the situation of the environmental space to the user and implement the real-time interaction.

In summary, the human-environment interactive system and the portable device using the same provide an overall solution for people with limited mobility. In the technical resolution, the user can actively and effectively learn the situation of the environmental space, so as to implement the real-time interaction. In this way, the user can ubiquitously operate various home-equipment in daily life, and such technical solution avails creating a more convenient life with better quality.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A portable device, suitable for two-way communicating with a ubiquitous computing system, the ubiquitous computing system having a plurality of computing devices, and the portable device comprising:
a radio frequency (RF) transceiver;
a browser; and
a controller, coupled to the RF transceiver and the browser,
wherein when the portable device is taken into an environmental space, the controller actively receives a set of situational information related to the environmental space from the ubiquitous computing system through the RF transceiver, and the set of situational information comprises status information of at least one home-equipment, and real-time position information of the portable device;
wherein the controller displays the set of situational information in the browser for a user to perceive variations of the surrounding environment, so as to operate the at least one home-equipment through the browser.

2. The portable device as claimed in claim 1, further comprising:
a first pan-tilt-zoom camera, coupled to the controller, and the first pan-tilt-zoom camera displaying a first camera image in the browser according to an operation of the user.

3. The portable device as claimed in claim 1, wherein the user performs operations through a graphical user interface of the browser, wherein the graphical user interface is a static graphical interaction interface or a reality interactive interface.

4. The portable device as claimed in claim 1, wherein the at least one home-equipment comprises a second pan-tilt-zoom camera, and the user performs remote control to the second pan-tilt-zoom camera through the browser, and displays a second camera image on the browser.

5. The portable device as claimed in claim 1, wherein when the user operates the at least one home-equipment through the browser, the portable device sends a wireless control signal to control an operation of the at least one home-equipment.

6. A human-environment interactive system, comprising:
a ubiquitous computing system, having a plurality of computing devices;
at least one home-equipment, located in an environmental space; and
a portable device, for two-way communicating with the ubiquitous computing system, and the portable device comprising:
a radio frequency (RF) transceiver;
a browser; and
a controller, coupled to the RF transceiver and the browser,
wherein when the portable device is taken into the environmental space, the controller actively receives a set of situational information related to the environmental space from the ubiquitous computing system through the RF transceiver, and the set of situational information comprises status information of the at least one home-equipment, and real-time position information of the portable device,
wherein the controller displays the set of situational information in the browser for a user to perceive variations of the surrounding environment, so as to operate the at least one home-equipment through the browser.

7. The human-environment interactive system as claimed in claim 6, further comprising:
a first pan-tilt-zoom camera, coupled to the controller, and the first pan-tilt-zoom camera displaying a first camera image in the browser according to an operation of the user.

8. The human-environment interactive system as claimed in claim 6, wherein the user performs operations through a graphical user interface of the browser, wherein the graphical user interface is a static graphical interaction interface or a reality interactive interface.

9. The human-environment interactive system as claimed in claim 6, wherein the at least one home-equipment comprises a second pan-tilt-zoom camera, and the user performs remote control to the second pan-tilt-zoom camera through the browser, and displays a second camera image on the browser, so as to provide the image to the reality interactive interface of the browser.

10. The human-environment interactive system as claimed in claim 6, wherein when the user operates the at least one home-equipment through the browser, the portable device sends a wireless control signal to control an operation of the at least one home-equipment.
